(19) United States
(12) Patent Application Publication
(10) Pub. No.: US 2006/0186191 A1
(43) Pub. Date: Aug. 24, 2006

(54) Methods and apparatus for providing a security value for a payment device

(76) Inventors: Ian T. Mitchell, Maineville, OH (US); Thomas B. Buckingham, Middletown, OH (US); Daniel M. Borchers, Dayton, OH (US); Harold John Berquist III, Barrington, IL (US); Spyros Menegatos, Milford, CT (US)

Correspondence Address: BUCKLEY, MASCHOFF, TALWALKAR LLC, 5 ELM STREET, NEW CANAAN, CT, 06840, US

(21) Appl. No.: 11/062,506

(22) Filed: Feb. 22, 2005

(51) Int. Cl. G07F 19/00

(52) U.S. Cl. 235/379

(57) ABSTRACT

Embodiments herein provide a system, method, apparatus, and computer program code to calculate a security value to associate with a payment device, to associate the security value with a print representation of the payment device where the security value and the payment device provide a unique combination, and to compare the security value associated with the payment device with known data regarding the payment device, including the security value. The security value may be used to verify an authenticity of the payment device and other information associated therewith, thus facilitating secure transactions based on using the payment device as a form of payment. In some embodiments, the payment device may include a check, a loan, an electronic transfer of funds, and other forms of payment.

### FIELD OF THE INVENTION

The present disclosure relates to a method and apparatus for providing a security value for a payment device and, more particularly, embodiments of the present disclosure relate to methods, means, apparatus, and computer program code for providing a security value that may be used to authenticate or verify information associated with the payment device.

### BACKGROUND OF THE INVENTION

In an effort to provide convenience and accessibility to customer-deposited, loan, credit and other types of funds, a bank, merchant, or other issuers of credit may desire to provide payment devices or resources for use or access by their customers. For example, a credit card issuer may authorize the issuance of a number of convenience checks to an existing customer. The convenience checks may be issued in a predetermined amount(s) or the customer may determine the amount(s). The convenience checks may be, for example, used by the customer at a point of sale (POS) for the purchase of goods and/or services or for cash (i.e., customer as payee).

It would be advantageous to provide a method and apparatus that overcame the drawbacks of the prior art. In particular, it would be desirable to provide a method and apparatus that facilitates the creation, distribution, acceptance, or processing of secure transactions using a secure payment device. In addition, it would be desirable to provide a method and apparatus for facilitating the creation, distribution, acceptance, or processing of secure transaction including printed payment devices and electronic transfers of funds.

### SUMMARY OF THE INVENTION

Applicant inventors have realized that while providing a payment device in a manner that offers greater convenience an/or access to funds for a customer, care should be taken to minimize risks (e.g., fraud) associated with the acceptance and transfer of funds associated with the payment device. The payment device may include, for example, a convenience check, a balance transfer check, a reward check, etc. The resource costs associated with implementing and maintaining fraud reduction measures of the payment device should not adversely impact the convenience afforded by the payment device. For example, a fraud reduction technique would benefit from being compatible with current and foreseeable future transaction methods and processes used with an associated payment device.

Various embodiments of the present disclosure provide a system, method, apparatus, means, and computer program code to calculate a security value to associate with a payment device, to associate the security value with a print representation of the payment device where the security value and the payment device provide a unique combination, and to compare the security value associated with the payment device with known data regarding the payment device, including the security value. The security value may be used to verify an authenticity of the payment device and other information associated therewith, thus facilitating secure transactions based on using the payment device as a form of payment. In some embodiments, the payment device may include a check, a loan, an electronic transfer of funds, and other forms of payment.

Additional objects, advantages, and novel features of the disclosure shall be set forth in part in the description that follows, and in part will become apparent to those skilled in the art upon examination of the following or may be learned by the practice of the disclosure.

### BRIEF DESCRIPTION OF THE DRAWINGS

The accompanying drawings, which are incorporated in and form a part of the specification, illustrate some embodiments of the present disclosure, and together with the descriptions serve to explain some of the principles of the disclosure.

FIG. 1 is a flowchart of an exemplary embodiment of a method in accordance with the present disclosure;

FIG. 2 is a flowchart of an exemplary embodiment of a method in accordance with the present disclosure;

FIG. 3 is an exemplary block diagram of system components in accordance with some embodiments of the present disclosure;

FIG. 4 is an exemplary flowchart of a process in accordance with the system of FIG. 3;

FIG. 5 is an exemplary block diagram of system components in accordance with some embodiments of the present disclosure;

FIG. 6 is an exemplary flowchart of a process in accordance with the system of FIG. 5;

FIG. 7 is an exemplary block diagram of system components in accordance with some embodiments of the present disclosure;

FIG. 8 is an exemplary flowchart of a process in accordance with the system of FIG. 7;

FIG. 9 an exemplary block diagram of an apparatus in accordance with some embodiments of the present disclosure; and

FIG. 10 an exemplary representation of a payment device including a security value thereon, in accordance with some embodiments of the present disclosure.

### DETAILED DESCRIPTION

Applicants have recognized that there is a need for systems, means and methods for creating, distributing, accepting, or processing of a secure transaction such as printed payment devices and electronic transfers related to same. A payment device may be used to purchase goods and services, open a loan, authorize a loan, and access a line of credit associated with a user of the payment device. The payment device may be related to one or more types of payments, such as, for example, a cash payment, a convenience check, a balance transfer check, a reward check, a loan, a line of credit, a revolving credit account, etc. In particular, applicants have recognized that there is a need for systems, means, computer code and methods for facilitating authentication and/or verification of a payment device intended for a creation, distribution, acceptance, or processing of a secure transaction using a payment device.

In some embodiments, a technical effect obtained by such systems, methods, etc. is that a measure of security is provided regarding a transaction including the payment device. In some embodiments, a transaction or process including the payment device is provided in an efficient and effective manner. These and other features will be discussed in further detail below, by describing a system, individual devices, and processes according to various embodiments herein.

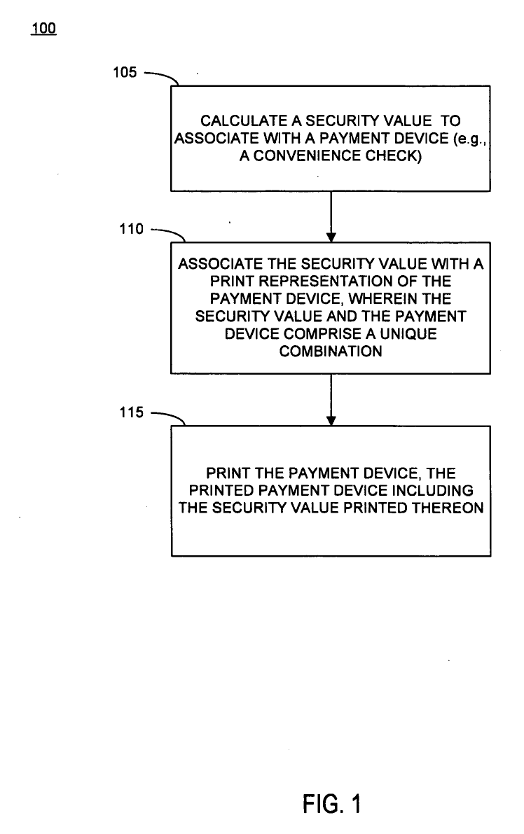

Reference is now made to FIG. 1, where an exemplary flowchart 100 is shown that represents an illustrative operation according to some embodiments of the present disclosure. The particular arrangement of elements in the flowcharts herein is not meant to imply a fixed order to the steps; embodiments of the present disclosure can be practiced in any order that is practicable. Process 100 may be suited for use in creating a payment device including a security value associated with the payment device (e.g., convenience check, a convenience check, a balance transfer check, a reward check, loan check, money order, line of credit check or voucher, etc.).

Process 100 is shown starting at an operation 105 wherein a security value is calculated. The security value is associated with a payment device to provide a measure of security thereto. The payment device may be any one of a number of presently known and future developed payments devices used effectuate a payment or transfer of funds. For example, a payment device may include but not be limited to a corporate or business check, a personal check, a convenience check, a line of credit check or voucher, a line of credit payment device, etc. Further, the payment device may be an electronic file that is compatible with an electronic transfer of funds process, including aspects of a U.S. federal law pertaining to the transfer of funds commonly referred to as “Check 21”.

In some embodiments, the security value is calculated using an algorithm. The algorithm may be varied depending on a number of features and criteria. The algorithm may vary depending of the level of security desired (i.e., robustness), the processing resources available to create and/or process the security value, a purpose or use for the payment device, etc. For example, the algorithm used to calculate the security value may be varied depending on the type of payment device that will be associated with the security value. As an example, a personal check may have a security value calculated according to one algorithm whereas a different payment device such as a corporate check may have a security value associated therewith that is calculated according to a different algorithm.

In some embodiments, the algorithm or mechanism to calculate the security value may be used, at least in part, as a basis for differentiating between various types of payment devices. For example, a company or service provider creating or processing payment devices in accordance with some embodiments herein may create or process a number of differing types of payment devices. Furthermore, the company may create a first payment device including a security value calculated using a first algorithm and a second payment device including a security value calculated using a second algorithm. The first payment device and the second payment device may be used by different divisions in the company, for different programs (e.g., a line of credit, a personal loan, an advance on a credit card, etc.), and for a variety of other differentiating purposes.

In some embodiments, a key or other mechanism for implementing the algorithm may be provided for calculating of the security value. The key may be provided to an entity that does the calculating of the security value and/or the processing of the payment device. In this manner, the entity creating the payment device need not know the algorithm. This aspect of the present disclosure may provide a measure of security regarding the processes, methods, systems, and other embodiments herein.

At operation 110, the security value is associated with a print representation of the payment device. To facilitate security aspects of the payment device associated with the security value, in some embodiments herein the combination of the payment device and the security value is unique. That is, the combination of the calculated security value and the particular instance of a payment device associated therewith form a unique combination. The uniqueness of the combination of the calculated security value and the payment device provide a mechanism that facilitates the authentication and/or verification of the payment device associated with the security value.

In some embodiments herein, a combination of a calculated security value and a payment device are associated to form a unique combination that may be used to facilitate an authentication and/or verification of information or point to information associated with the payment device. Such information may include specific data printed on the payment device, information associated with an account related to the payment device, information associated with a payee or payor associated with the payment device, etc. In this manner, a reference to information not directly included on a printed or included in a print representation of a payment device may be referenced in accordance with embodiments of the present disclosure . This includes any information present in the MICR line and resulting MICR information transfers.

In some embodiments, access to information associated with a payment device that is authenticated and/or verified or pointed to based on, at least in part, a security value associated with the payment device may be limited pending verification of a uniqueness of the combination of the calculated security value and the payment device associated therewith. For example, a verification of the authenticity and uniqueness of the combination of a payment device and the calculated security value associated therewith may be determined prior to allowing a release, transfer, or otherwise access to further information associated with the payment device.

Continuing with process 100 for creating a secure payment device, at operation 115 the payment device is printed. Operation 115 includes printing the print representation of the payment device of operation 110 including the security value thereon. In some embodiments, the security value is printed in a location and/or according to accepted methods and techniques provided for the printing of the payment device of the present disclosure. That is, the payment device may be printed in accordance with a number of formats, techniques, and methods suitable for the payment device.

In some embodiments, the payment device is printed such that it is at least compatible with current methods and techniques for the printing payment devices. In that different payment devices may be printed using various different printing media, processes, and techniques, a printing in accordance with operation 115 may encompass a number of various different printing media, processes, and techniques. In some embodiments for example, a payment device such as a convenience check created in accordance with process 100 may be accepted and processed in a manner consistent, in part, with currently existing printed check processing methods and techniques. Accordingly, the payment device created in accordance with process 100 may be printed, in part, in accord with existing printed payment device formats and techniques.

In some embodiments, operation 115 may be performed, if at all, after a period of intervening time between operation 110 and operation 115. In the interim time period, a number of processes or events may transpire regarding the payment device. In some embodiments, operation 115 may not be performed and yet the payment device created in accordance with process 100 is benefited by having the security advantages provided by having the security value associated with the payment device. For example, in some embodiments a payment device and more particularly a print representation thereof, created in accordance with aspects of process 100 may be used in an electronic fund transfer process. As a consequence of being used in an electronic fund transfer process, the payment device may not be printed since the transfer and records regarding the transfer of funds may occur entirely electronically.

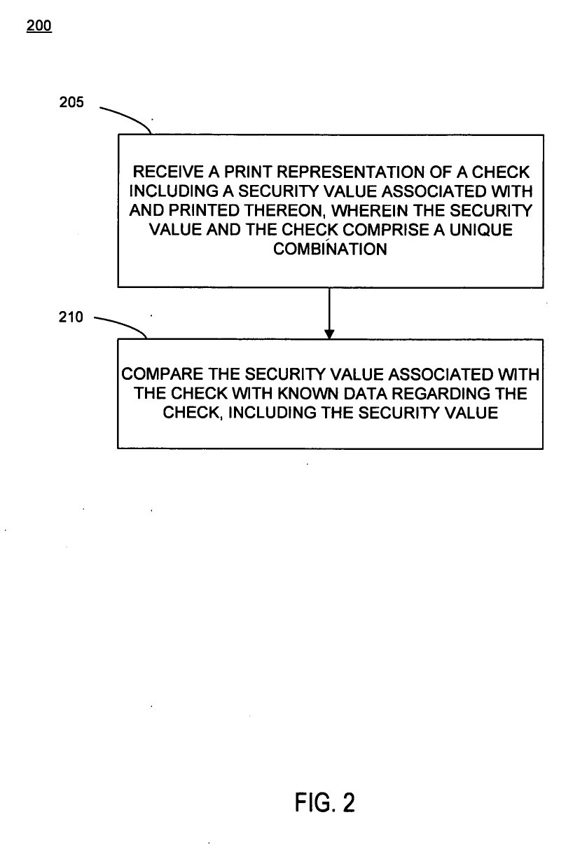

FIG. 2 provides a depiction of an exemplary process for processing a secure payment device. At operation 205, a print representation of a payment device (e.g., a check) is received that has a calculated security value associated therewith. In some embodiments, the print representation may be a printout of the payment device, a printout of a truncated or alternate version of the payment device, or an electronic representation of the payment device.

In some embodiments herein, the payment device of process 200 and the calculated security value associated therewith combine to form a unique combination. That is, the combination of the payment device and the calculated security device provide a unique combination for the type of payment device subject to process 200.

At operation 210, the calculated security value associated with the payment device of operation 205 is compared to known data regarding the payment device. In some embodiments, the combination of the calculated security value and payment device that form a unique combination is considered in the comparison process of operation 210.

The known data may include information that may be derived given the security value associated with the payment device. For example in the instance the payment device is a pre-printed convenience check issued to a credit card account customer in the account customer's monthly bill, the known amount of the issued check, the known payee of the issued check, a known expiration date for the issued check, etc. may be compared to the information actually printed on the check. Any discrepancies in the comparing process of operation 210 may raise a flag, stop process 200, trigger alternate processing operations, or result in the rejection of the payment device for continued processing.

In some embodiments, given the security value associated with the print representation of the payment device received at operation 205, a comparison may be made in operation 210 that includes deriving certain information and comparing the derived information with known data for the payment device. For example, the security value and a certain calculating key or mechanism may be used to determine if the security value is in fact properly associated the payment device. That is, although the payment device has a seemingly acceptable security value, a determination may be made to determine if the security value is associated with an acceptable, particular payment device. This type of determination may be made as a part of the comparison of operation 210 since the combination of the security value and the payment device is unique in some embodiments herein. For example, for a given security value associated with a particular payment device operation 210 may determine the account number for the payment device that should be associated with the security value, based on the security value and a key or other calculating mechanism. Operation 205 may further compare the derived account number with the known account number, as issued by the credit card company, bank, financial institution, or other entity that is tasked with processing of the payment device (e.g., physical document and/or electronic fund transfer, E.F.T.).

The algorithm may be varied depending on a number of features and criteria. Some of the criteria may include, but need not be limited to, a level of security (i.e., robustness) desired, the processing resources available to create and/or process the security value, a purpose or use for the payment device, etc. For example, the algorithm used to calculate the security value may be varied depending on the type of payment device that will be associated with the security value. As an example, a corporate check may have a security value calculated according to one algorithm whereas a different payment device such as a loan check may have a security value associated therewith that is calculated according to a different algorithm.

In some embodiments, the algorithm or mechanism to calculate the security value may be used, at least in part, as a basis for differentiating between various types of payment devices. For example, an entity or service provider creating or processing payment devices in accordance with some embodiments herein may create or process a number of differing types of payment devices. Furthermore, the entity may create a first payment device including a security value using a first algorithm and a second payment device including a security value using a second algorithm. The first payment device and the second payment device may be used by different divisions in the company, for different programs (e.g., a line of credit, a personal loan, an advance on a credit card, etc.), and for a variety of other differentiating purposes.

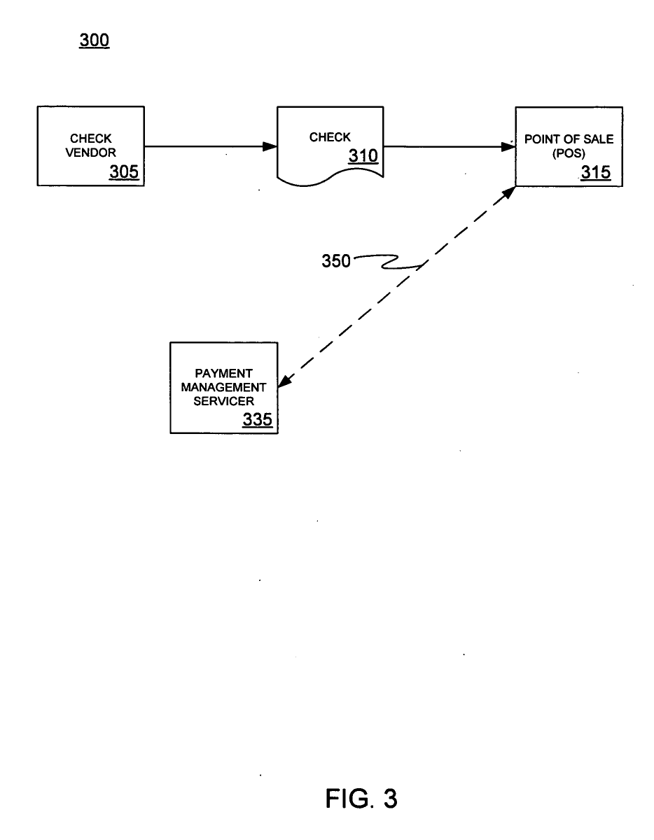

FIG. 3 depicts an exemplary block diagram regarding an environmental context or system to implement some embodiments of the present disclosure, generally represented by reference number 300. In some embodiments, environmental context or system 300 may include a check vendor 305 that generates or creates a printed check 310, a point of sale (POS) merchant 315 that accepts check 310 in exchange for goods and/or services rendered thereby, a payment management servicer 335 that, inter alia, may authenticate and/or verify a security value associated with check 310. Payment management servicer 335 provides, for example, authentication services regarding funds associated with check 310. Payment management servicer 335 may communicate with POS 315 via a communication link 350. Communication link 350 may be any one of or a combination of a wired, wireless, dedicated, public, connect as needed, store and forward, instant, or other type of communication link. System 300 may be used to implement at least some of the processes depicted in FIGS. 1 and 2.

In some embodiments herein, system 300 is used to facilitate authorization processing of check 310 in a substantially real-time context. That is, POS 315 communicates with payment management servicer 335 to request an authorization (i.e., an approval) of check 310 for the sale of goods/services for the amount indicated on check 310. The request for authorization may be communicated to payment management servicer 330 over communication link 350. Payment management servicer 330 provides the service of authorizing check 330. Payment management servicer 335, in some embodiments, has access to information for providing a determination regarding the authorization of check 310. The information for facilitating the authorization determination may be stored or accessed by payment management servicer 335 from a local or distributed data store(s).

Upon making a determination regarding the authenticity and approval of check 310 for the amount indicated thereon, payment management servicer 330 communicates with POS 315 to notify POS 315 the result of the determination. The notification of the authorization determination may be communicated to payment POS 315 over communication link 350. The communication between POS 315 and payment management servicer 335 and the authorization process is accomplished, in some embodiments, in substantially real-time.

The authorization of check 310 may include providing a guarantee or verification of the availability of the funds to make the purchase. That is, the funds as indicated on check 310 are available for the sale at POS 315.

In some embodiments, payment management servicer 330 provides payment management services that do not require the physical embodiment of check 310. Payment management servicer 330 instead works with electronic information obtain from check 310, such as a MICR line of information. Payment management servicer 335 may process the electronic information regarding check 310 in a manner similar to the processing that may be provided in the instance of a credit card, check card, private label credit card, or other electronic fund transfer transactions.

To facilitate an authorization process that is substantially real-time, the request for authorization from POS 315, the communication of the request to payment management servicer 335, the authorization determination, and the communication of the notification of the authorization determination from payment management servicer 335 to POS 315 is accomplished in a time interval that is not disruptive to a payment transaction at POS 315. For example, an authorization sequence of events (e.g., request through notification) may be accomplished in about one minute, and preferably less than about 15 seconds to 30 seconds.

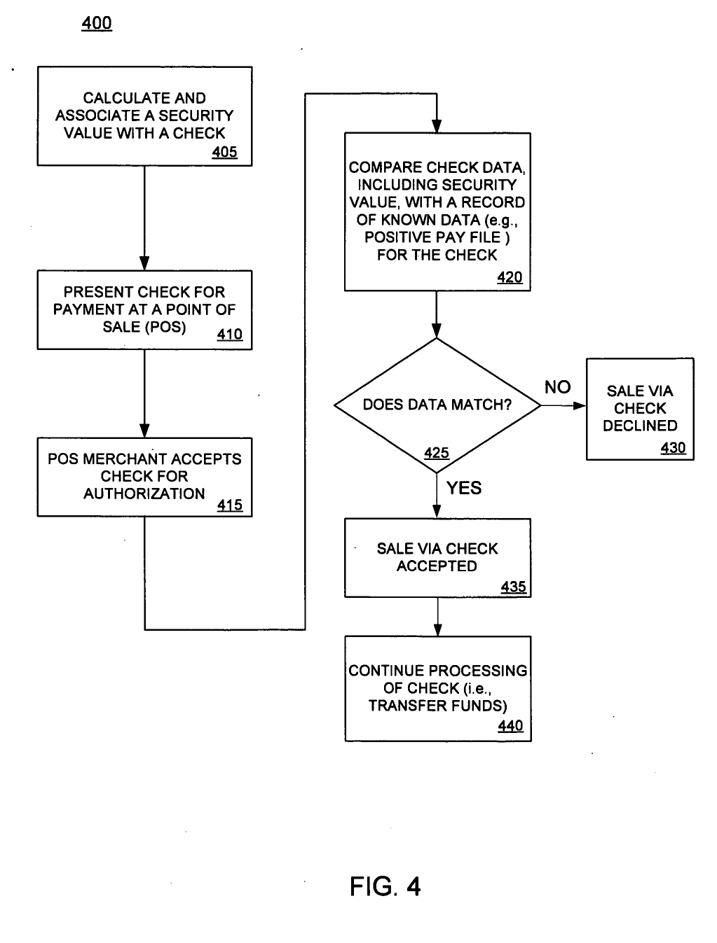

In some embodiments, system 300 may be used to implement a process in accordance with an exemplary flowchart shown in FIG. 4. Process 400 includes an operation 405 in which a security value is calculated and associated with a check (e.g., check 310 of FIG. 3). Check vendor 305 may provide a print representation of the check. The print representation may be an electronic file including a data representaton of the check, including a security value associated therewith.

In some embodiments, check vendor 305 may be provided with a key that is used in conjunction with an algorithm to calculate the security value that is printed on check 310. The algorithm may be kept confidential and only the key or other calculating mechanism may be provided to check vendor 305.

At 410, check 310 may be presented for payment at a POS 315 in exchange for goods and/or services. In a POS transaction, the check may be accepted for authorization regarding the purchase of the goods and/or services at 415. Payment management servicer 335 may provide an authorization or verification service in substantially real-time for the check that includes the security value associated therewith.

At operation 420, a comparison of data on or associated with check 310, including the associated security value is performed. The comparison may include comparing the information on or associated with the print representation of check 310 with a record of known data. The record of known data may include information such as, for example, a positive pay file that includes known information for the check as provided by an entity that authorized or created check 310 such as, for example, check vendor 305.

At 425, a determination is made whether the data of check 310 matches the known data as compared in operation 420. If the comparison does not result in a data match, then a notification of the failed match is communicated to POS 315 and the sale is declined for the purchase at the POS and process 400 stops at operation 430.

If the comparison results in a data match, then a notification of the match is communicated to POS 315 and the sale via the check is approved for the purchase at the POS using check 310 at 435. Process 400 then proceeds to operation 440. Further processing of electronic information associated with check 310 (e.g., MICR line information) occurs at operation 440. The further processing may include steps necessary to complete the transfer of funds to an account of the POS merchant.

In some embodiments of the various methods disclosed herein, including but not limited to the method of FIG. 4, the authorization or verification of the payment device and the associated security value may be performed in substantially real-time. That is, the authorization process, including the comparison of payment device information with, for example, known data for the payment device may be accomplished in a relatively fast manner so as to be compatible with a transaction involving the payment device. For example, in the context of FIG. 4, operations 420 and 425 may be accomplished in a relatively fast or real-time manner such that the time to complete operations 420 and 425 is within acceptable timeframes for conducting a purchase using, for example, a check at a retail POS. That is, the time required to authenticate or verify the payment device and the associated security value may be acceptable and compatible with a transaction, a payment or an application for which the payment device is used.

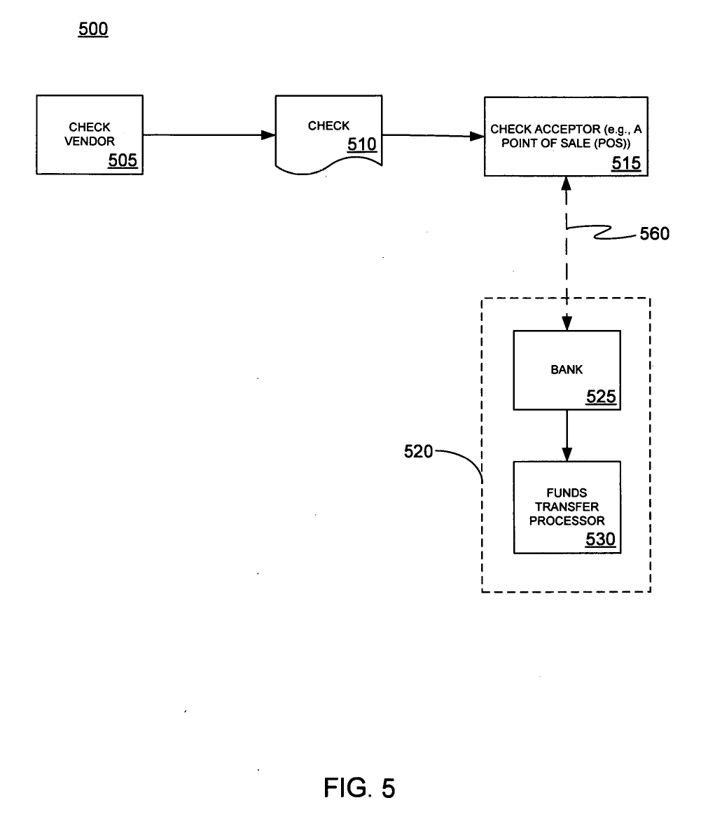

FIG. 5 depicts an exemplary block diagram regarding an environmental context or system to implement some embodiments of the present disclosure, generally represented by reference number 500. In some embodiments, environmental context or system 500 may include a check vendor 505 that generates or creates a printed check 510 (e.g.,a loan check, a convenience check, etc.), a check acceptor 515 (e.g., a point of sale (POS) merchant) that accepts check 510 in exchange for goods and/or services rendered thereby, a check processing operation 520 that, for example, may authenticates and/or verify a security value associated with check 510 and provides processing to effectuate a transfer funds. Check processing operation 520 may provide, for example, authentication services regarding funds associated with a physical embodiment of check 510. Check processing operation 520 may communicate with check acceptor 515 via a communication link 560. Communication link 560 may be any one of or a combination of a wired, wireless, dedicated, public, connect as needed, store and forward, or other type of communication link. System 500 may be used to implement at least some of the processes depicted in FIGS. 1 and 2.

In some embodiments herein, system 500 is used to facilitate check deposit and authorization processing of a physical embodiment of check 510, including but not limited to a processing involving the deposit of check 510 with a bank and processing with, for example, the Federal Reserve system. Check processing operation 520 provides the service of authorizing check 510. Check processing operation 520, in some embodiments, has access to information for providing a determination regarding the authorization of check 510. The information for facilitating the authorization determination may be stored or accessed by check processing operation 520 from a local or distributed data store(s).

Check processing operation 520 further includes a bank 525 to which check 510 may be deposited by check acceptor 515 and a funds transfer processor 530. Funds transfer processor 530 may include a number of entities to effectuate (backend) processing operations to complete the transfer of funds from an account of the check 510 payor to the check acceptor 515, including a number of banks, financial institutions, Federal Reserve, etc.

Upon making a determination regarding the authenticity and approval of check 510 for the amount indicated thereon, check processing operation 520 may communicate with POS 515 to notify POS 515 the result of the determination in an instance check 510 is unauthorized (e.g., a fraudulent payment device, insufficient funds, etc.). The notification of the authorization determination may be communicated to check acceptor 515 over communication link 560 or via a statement from bank 525 to check acceptor 515.

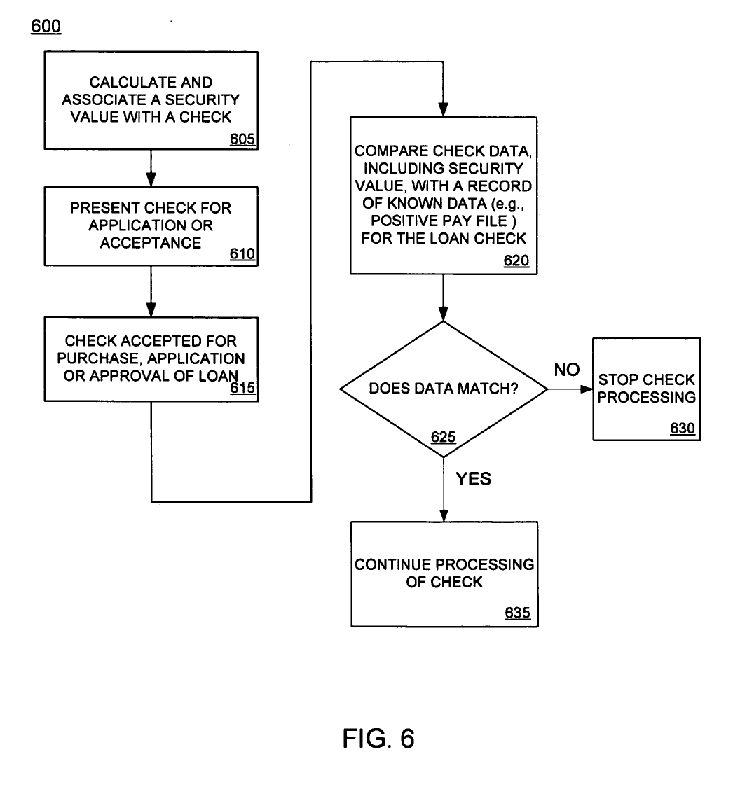

In some embodiments, system 500 may be used to implement a process in accordance with an exemplary flowchart shown in FIG. 6. Process 600 includes an operation 605 in which a security value is calculated and associated with a check (e.g., check 510 of FIG. 5). The print representation may be a physical embodiment of the check or a physical embodiment carrying certain aspects of the check, including a security value associated therewith.

In some embodiments, check vendor 505 may be provided with a key that is used in conjunction with an algorithm to calculate the security value that is printed on check 510. The algorithm may be kept confidential and only the key or other calculating mechanism may be provided to check vendor 505.

At 610, the check may be presented for payment or application or acceptance of a loan at a check acceptor 515 in exchange for goods and/or services (e.g., a loan). The check may be accepted for the purchase, application, or approval of a loan at operation 615.

The check may be deposited with check processing operation 520. Check processing operation 520 may provide an authorization or verification service for the check that includes a comparison/verification of the security value associated therewith.

At operation 620, a comparison of data on or associated with check 510, including the associated security value is performed. The comparison may include comparing the information on or associated with a printed representation of check 510 with a record of known data. The record of known data may include information such as, for example, a positive pay file that includes known information for the check as provided by an entity that authorized or created check 510 such as, for example, check vendor 505. The comparison may be accomplished by the funds transfer processor 530 show in FIG. 5.

At 625, a determination is made whether the data of check 510 matches the known data as compared in operation 620. If the comparison does not result in a data match, then a notification of the failed match may be communicated to bank 525 and/or check acceptor 515 and the check is flagged or otherwise pulled for review.

If the comparison results in a data match, then 600 proceeds to continue processing the check to effectuate the transfer of funds to the check acceptor 515. The further processing may include steps necessary to complete the transfer of funds to an account of the check acceptor, such as processing the check through the Federal Reserve system. If the comparison does not result in a data match, then 600 proceeds to operation 630 where the processing of the check is stopped.

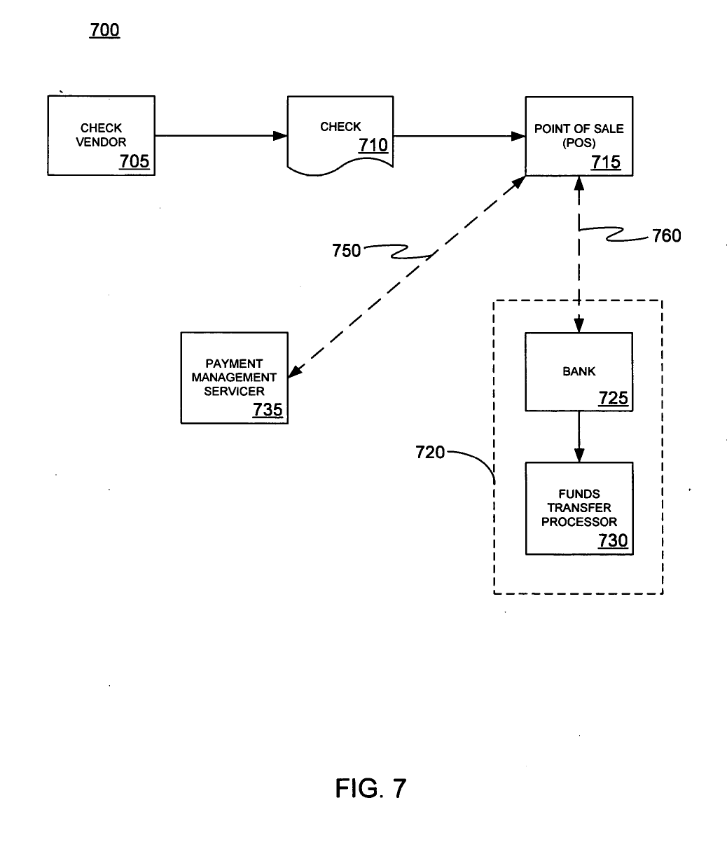

FIG. 7 is an exemplary block diagram regarding an environmental context or system to implement some embodiments of the methods of the present disclosure, generally represented by the reference number 700. In some embodiments, environmental context or system 700 may include a check vendor 705 that generates or creates a print representation of a check 710, a check representation acceptor 715 that accepts loan check 710 in exchange as, for example, a sale, an application for a loan or authorization to process a loan, a check processing operation 720, and a payment management servicer 735 that, inter alia, may independently or in cooperation with each other authenticate and/or verify a security value associated with check 710. System 700 may also include a bank 725 and other financial institutions 730 that provide processing (backend) services associated with check 710. Funds transfer processor 730 may process check 710 to effectuate a transfer of funds as indicated by check 710. System 700 may be used to implement at least some of the operations depicted in FIGS. 1, 2, 4, and 6.

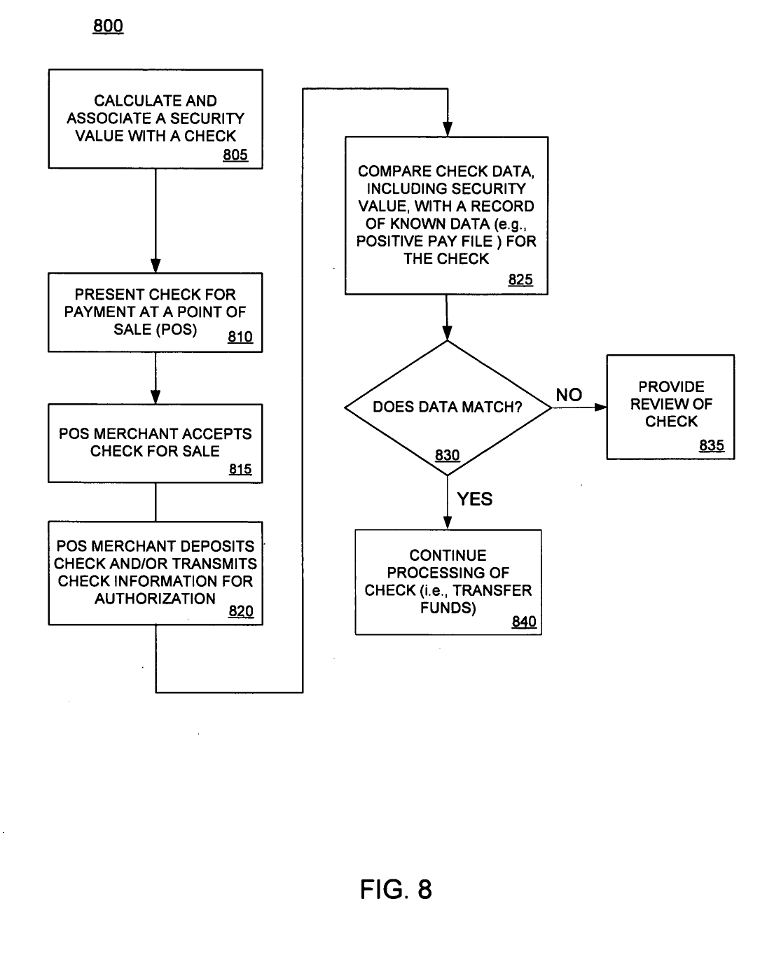

In some embodiments, system 700 may be used to implement a process 800 in accordance with an exemplary flowchart shown in FIG. 8. Process 800 includes an operation 805 in which a security value is calculated and associated with a loan (e.g., check 710 of FIG. 7). Check vendor 705 may provide a print representation of the check, including a security value associated therewith.

In some embodiments, check vendor 705 may be provided with a key that is used in conjunction with an algorithm to calculate the security value that is printed on check 710. The algorithm may be kept confidential whereas only the key or other calculating mechanism may be provided to check vendor 705.

At 810, check 710 may be presented for acceptance at a POS. The POS merchant may be a retail establishment, a bank, a mortgage company, or other entity accepting a check or other payment device. The check may be accepted for authorization regarding a sale at 815. The POS merchant accepts the check at operation 815.

At operation 820, the check may be deposited with a bank (e.g., bank 725) for check processing and/or relevant information (e.g., a security value) from the check may be provided to a payment management servicer 735.

An authorization or verification service for the loan check that includes the security value associated therewith may be provided at operation 825. At 825, a comparison of data on or associated with check 710, including the associated security value is performed. The comparison may include comparing the information on or associated with the print representation of check 710 with a record of known data. The record of known data may include information such as, for example, a positive pay file that includes known information for the loan check as provided by an entity that authorized or created check 710 such as, for example, check vendor 705.

In the instance the check representation (e.g., an electronic file including security value information of the check) is authorized by payment management servicer 735, the comparison (i.e., authorization process) of operation 825 may be performed in a substantially real-time timespan.

In the instance the check (e.g., physical embodiment including security value information of the check) is authorized by payment management servicer 735, the comparison (i.e., authorization process) of operation 825 may be performed by check processing operation as a part of a backend processing operation to process the physical check through a number of banks and the Federal Reserve system.

In some embodiments, system 700 and process 800 may be used to handle the processing of a payment device that includes processing physical embodiment of the payment device in some or all aspects of the processing cycle and processing of an electronic representation of the payment device in some or all aspects of the processing cycle. For example, communication link 750 and payment management servicer 735 may be used to provide real-time authorization using an electronic file including payment device information including an associated security value. Communication link 760 and check processing operation 720 may be used to provide (backend) authorization using a physical paper embodiment of a payment device including an associated security value.

As a result of the comparison at 825, process 800 proceeds to operation 830. Operation 830 determines whether there was a match as a result of the comparison of operation 825. If there is a match, the process proceeds to 840 to continue further processing of the payment device (i.e., the check). The processing of operation 840 may be provided by payment management servicer 735, check processing operation 720, and a combination thereof. If there is not a match at operation 830, then process 800 proceeds to 835 to stop a transfer of funds, at least until a further review of the check information is performed.

In some embodiments herein, the security value can be validated in a number of ways including, for example, (1) comparing the security value that is actually on or associated with the payment instrument (e g., a check) against a stored security value in a file (e.g., a positive pay file) or (2) calculating the security value based on information on or associated with the payment device (e.g., an account number, a serial number, etc) and a key and validating the calculated security value against the security value actually printed on or associated with the payment device (e.g., a check).

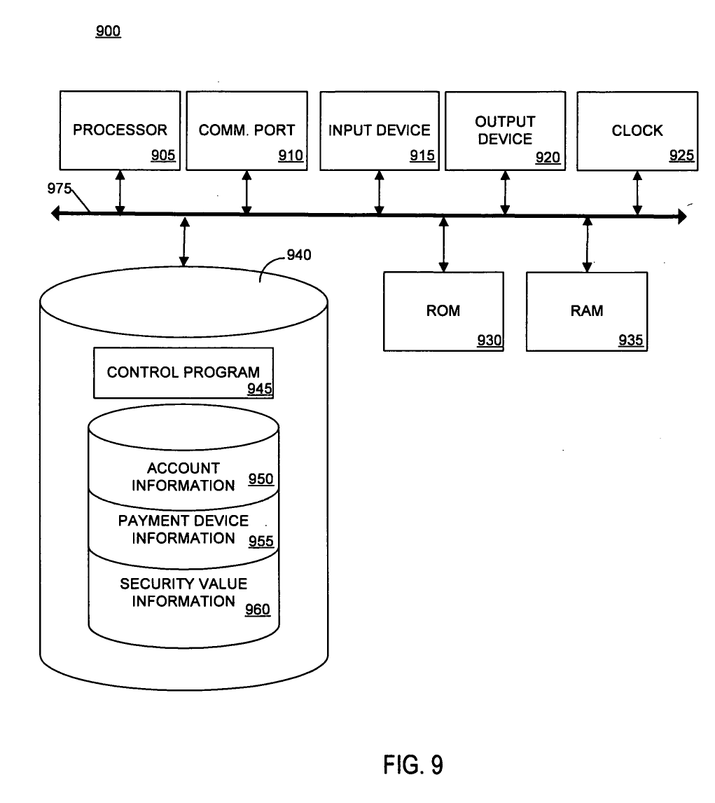

Now referring to FIG.9 an exemplary, representative block diagram of a server or controller 900 is illustrated. Server 900 may be used in the creation, processing, or controlling of the creating and/or processing of a payment device in accordance with some of the embodiments herein. Server 900 may include a processor, microchip, central processing unit, or computer 905 that is in communication with or otherwise uses or includes one or more communication ports 910 for communicating with user devices and/or other devices. Communication ports 910 may include local area network adapters, wireless communication devices, Bluetooth technology, etc. Server 900 may include an internal clock element 925 to maintain an accurate time and date for server 900, create time stamps for communications received or sent by server 900, etc.

In some embodiments, server 900 may include one or more output devices 920 such as a printer, infrared or other transmitter, antenna, audio speaker, display screen or monitor, text to speech converter, etc., as well as one or more input devices 915 such as a bar code reader, magnetic ink character recognition scanner or reader, or other optical scanner, infrared or other receiver, antenna, magnetic stripe reader, image scanner, roller ball, touch pad, joystick, touch screen, microphone, computer keyboard, computer mouse, etc.

Server 900 may also include a memory or data storage device 940 to store information, software, databases, communications, device drivers, account information, statement information, security codes, security algorithms, etc. Memory or data storage device 940 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. Server 900 also may include separate ROM 930 and RAM 935.

Processor 905 and data storage device 940 in server 900 each may be, for example: (i) located entirely within a single computer or other computing device; or (ii) connected to each other by a remote communication medium, such as a universal serial bus cable, serial port cable, telephone landline, cellular network link or radio frequency transceiver. In some embodiments, server 900 may comprise one or more computers that are connected to a remote server computer for maintaining databases.

A personal computer or workstation with sufficient memory and processing capability may be used as server 900. In some embodiments, Server 900 operates as or includes a Web server for an Internet environment. Server 900 is preferably capable of high volume transaction processing, performing a significant number of mathematical calculations in processing communications and database searches.

Software may be resident and operating or operational on server 900. The software may be stored on data storage device 940 and may include a control program 945 for operating the server, databases, etc. Control program 945 may control processor 905. Processor 905 preferably performs instructions of control program 945, and thereby operates in accordance with the present disclosure, and particularly in accordance with the methods described in detail herein. Control program 945 may be stored in a compressed, uncompiled and/or encrypted format. Control program 945 may include program elements that may be necessary, such as an operating system, a database management system and device drivers for allowing the processor 905 to interface with peripheral devices, databases, etc. Appropriate program elements are known to those skilled in the art, and need not be described in detail herein.

Server 900 also may include or store information regarding users, user devices, payment devices, accounts, security values, security value algorithms, communications, etc. For example, information regarding one or more accounts may be stored in an account information database 950 for use by server 900 or another device or entity and information regarding one or more payment devices may be stored in a payment device database 955 for use by server 900 or another device or entity. Information regarding the calculating of security values (e.g., algorithms, keys, and calculated security values) for one or more payment devices may be stored in a security value information database 960 for use by server 900 or another device or entity. In some embodiments, some or all of one or more of the databases may be stored or mirrored remotely from server 900.

According to an embodiment of the present disclosure, the instructions of the control program may be read into a main memory from another computer-readable medium, such as from ROM 930 to RAM 935. Execution of sequences of the instructions in the control program causes processor 905 to perform the process steps described herein. In some embodiments, hard-wired circuitry may be used in place of, or in combination with, software instructions for implementation of some or all of the methods of the present disclosure. Thus, embodiments of the present disclosure are not limited to any specific combination of hardware and software.

Processor 905, communication port 910, clock 925, output device 920, input device 915, data storage device 940, ROM 930, and RAM 935 may communicate or be connected directly or indirectly in a variety of ways. For example, processor 905, communication port 910, clock 925, output device 920, input device 915, data storage device 945, ROM 930, and RAM 935 may be connected via a bus 925.

While specific implementations and hardware configurations for servers 900 have been illustrated, it should be noted that other implementations and hardware configurations are possible and that no specific implementation or hardware configuration is needed. Thus, not all of the components illustrated in FIG. 9 may be needed for a server implementing the methods disclosed herein.

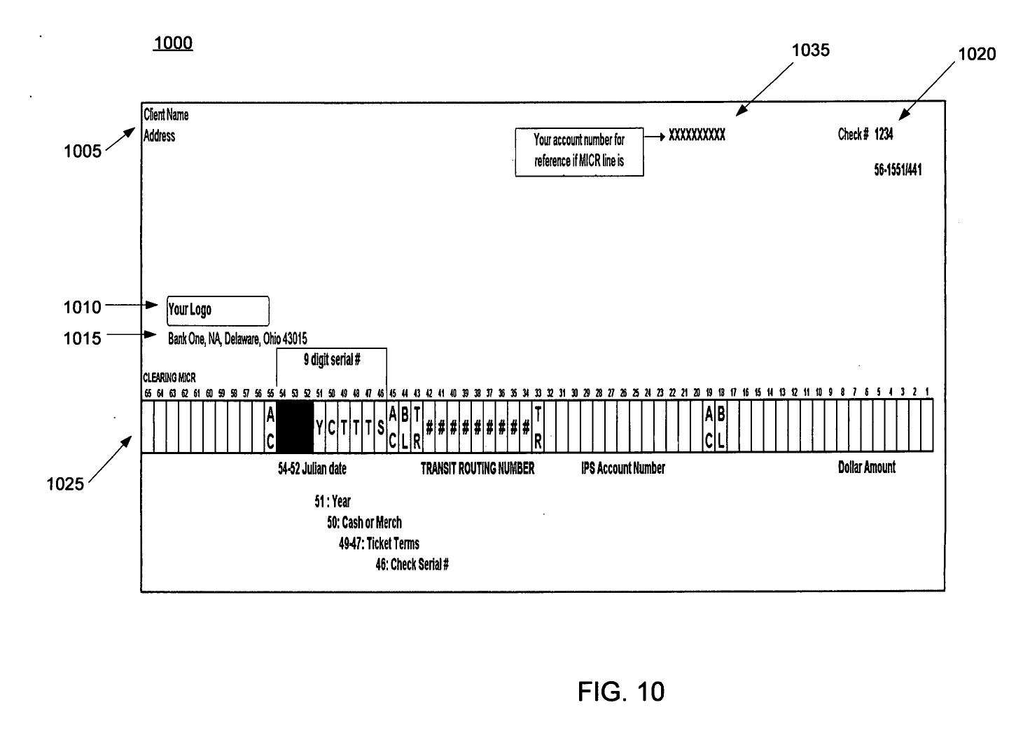

Reference is now made to a check 1000 shown in FIG. 10. In some embodiments herein, a print representation of a payment device (i.e., check) may be created that is formatted similar to a check. Check 1000 includes an area 1005 for an account owner's name and other identifying information, an area 1010 that may include a company name and/or logo for the account owner, and an area 1015 to include information regarding the name and other information regarding the financial institution the check is drawn against. Also, check 1000 includes a check sequence number at 1020.

Check 1000 may include a line of magnetic ink character recognition (MICR) characters 1025. It should be appreciated that MICR line 1025 may be formatted in accordance with generally acceptable MICR formatting schemes. In this manner, check 1000 may be created, processed, and received by existing compatible machines for the processing and handling of same. Additionally, the appearance of check 800 may also appear substantially unchanged from a known configuration of a printed check to a person handling or viewing the check. In some embodiments herein, the calculated security value may be included in the MICR line of check 1000. To comply with other benefits and advantages provided by the present disclosure, MICR line 1025 may include the calculated security value therein. For example, the calculated security value may include three alpha-numeric digits. The calculated security value may further be incorporated into MICR line in an unobtrusive manner.

For example, the MICR line 1025 may include the security value in a pre-determined location. The calculated security value may be included in MICR line 1025 at locations 52 through 54. According to some formatting schemes for a MICR line, locations 52 through 54 thereof may be used for a Julian date entry. However, in accordance herewith locations 52 through 54 may instead include a calculated security value.

In some embodiments, the pre-determined location of the calculated security value is used in the creating and processing of the check. For example, a check vendor will know where to locate the calculated security value and the entity or entities that process the check will know where to look for the calculated security value, if at all. In some embodiments where the calculated security value is incorporated into a standardized MICR line, a need to modify or alter the methods and techniques for creating and processing a check thus formatted should be minimized.

In some embodiments, the security value may not be located in MICR line 1025. The calculated security value may be placed in an area such as, for example, are 1035. Area 1035 is spaced apart from MICR line 1025. When printed in area 1035, the calculated security value may or may not be printed using magnetic ink that may be processed using magnetic ink character recognition techniques. In some embodiments, optical scanners, readers, and other machine executable identifier techniques and methods other than or in addition to a magnetic ink character recognition technique may be used to identify and recognize the calculated security value placed on check 1000.

It should be appreciated that the format used for MICR line 1025 may vary depending on industry standards, type of payment device (e.g., corporate or personal check), user preferences, and other factors. Other factors that may impact the format of MICR line may include the length of the calculated security value.

In some embodiments, the security value may be calculated using a variety of data or information associated with the check associated therewith. For example, a check sequence number for the check (e.g., shown at 1020) and account number (e.g., located at location 1040) may be used in a process of calculating the security value. It should be appreciated that an algorithm or other security value calculating mechanism may use the check sequence number and the account number, or other information associated with the check. For example, information not located on the printed check (e.g., date account created, etc.) may be used in the calculating of the security value. Additionally, as mentioned hereinabove, a key may be used that is determinative in calculating the security value.

In some embodiments herein, the security value may be calculated using an algorithm that uses a variety of encryption and decryption techniques and methods. For example, the security code may be calculated or determined using a form of DES encryption that uses three separate 56-bit keys to encrypt and decrypt messages (i.e., triple DES). It should be appreciated however, that the type of, if any, encrypting used to calculated the security value herein may vary.

In some embodiments, methods of the present disclosure may be embodied as a computer program developed using, for example, an object oriented language that allows the modeling of complex systems with modular objects to create abstractions that are representative of real world, physical objects and their interrelationships. However, it would be understood by one of ordinary skill in the art that some embodiments disclosed herein may be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present disclosure and the accompanying claims should not be construed as being limited to any particular order or sequence, unless specifically indicated.

Some of the methods described above can be performed on a single computer, computer system, microprocessor, etc. In some embodiments, two or more of the steps in each of the methods described above could be performed on two or more different computers, computer systems, microprocessors, etc., some or all of which may be locally or remotely configured. In some embodiments, some of the methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present disclosure has been presented with respect to various embodiments thereof, those skilled in the art will note that various substitutions may be made to those embodiments described herein without departing from the spirit and scope of the present disclosure.

The words “comprise,” “comprises,” “comprising,” “include,”“including,” and “includes” when used in this specification and in the following claims are intended to specify the presence of stated features, elements, integers, components, or steps, but they do not preclude the presence or addition of one or more other features, elements, integers, components, steps, or groups thereof.

1. A method for creating a secure check, comprising:
calculating a security value to associate with a check; and
associating the security value with a print representation of the check; wherein the calculated security value is based on information associated with the check, consists of a plurality of numerical digits, and the security value and the check comprise a unique combination; and
printing the check, including the security value thereon, based on the print representation, wherein the security value is printed in a magnetic ink character recognition (MICR) line of characters.

2. (canceled)

3. The method of claim 2, wherein the security value is printed on the check apart from other alpha-numeric characters.

4. (canceled)

5. The method of claim 4, wherein said MICR line of characters is formatted based on one of a corporate payment device format and a personal payment device format.

6. The method of claim 4, wherein the MICR line of characters only includes the security value.

7. The method of claim 1, wherein the calculating is determined based on at least one of the following: a sequence number for the check, an account number associated with the check, and a selectable key.

8. The method of claim 7, wherein the selectable key is provided to an entity to print the check.

9. The method of claim 1, wherein the security value consists of two numerical digits.

10. The method of claim 1, wherein the security value consists of three numerical digits.

11. A method to facilitate processing of a secure check, comprising:
receiving a check including a security value associated with and printed thereon, wherein the security value is printed in a magnetic ink character recognition (MICR) line of characters, consists of a plurality of numerical digits, and the security value and the check comprise a unique combination; and
comparing the security value associated with the check with known data regarding the check, including the security value.

12. The method of claim 11, further comprising calculating the security value.

13. The method of claim 11, wherein the check is received at a point of sale (POS).

14. The method of claim 11, wherein the comparing is performed prior to an acceptance of the check by a payee of the check.

15. The method of claim 11, wherein the security value has an associated time period of validity.

16. The method of claim 11, further comprising reading the security value using a magnetic ink character recognition (MICR) technique or optical recognition technique.

17. The method of claim 11, wherein the calculating is determined based on at least one of the following: a sequence number for the check, an account number associated with the check, and a selectable key.

18. The method of claim 17, wherein the selectable key is provided to an entity to print the check including the security value thereon.

19. (canceled)

20. The method of claim 11, wherein the MICR line of characters is formatted based on one of a corporate payment device format and a personal payment device format.

21. The method of claim 11, wherein the security value consists of two numerical digits.

22. The method of claim 11, wherein the security value consists of three numerical digits.

23. A system to facilitate processing of a secure check, comprising:
a memory; and
a processor connected to the memory, the processor being operative to:
calculate a security value to associate with a check; and
associate the security value with a print representation of the check, wherein the calculated security value is based on information associated with the check and the security value and the check comprise a unique combination; and
print the check, including the security value thereon, based on the print representation, wherein the security value is printed in a magnetic ink character recognition (MICR) line of characters and consists of a plurality of numerical digits.

24. (canceled)

25. (canceled)

26. The system of claim 23, wherein the calculating is determined based on at least one of the following: a sequence number for the check, an account number associated with the check, and a selectable key.

27. The system of claim 26, wherein the selectable key is provided to an entity to print the check.

28. The system of claim 23, wherein the security value consists of two numerical digits.

29. The system of claim 23, wherein the security value consists of three numerical digits.

30. The system of claim 23, wherein the processor is further operative to compare the security value associated with the check with known data regarding the check, including the security value.

31. An article of manufacture having instructions embodied thereon, the instructions comprising:
instructions to calculate a security value to associate with payment device;
instructions to associate the security value with a print representation of the payment device, wherein the calculated security value is based on information associated with the check and the security value and the payment device comprise a unique combination; and
instructions to compare the security value associated with the check with known data regarding the check, including the security value, wherein the security value is included in a magnetic ink character recognition (MICR) line of characters of the print representation and consists of a plurality of numerical digits.
